(19) United States
(12) Patent Application Publication
(10) Pub. No.: US 2011/0222784 A1
(43) Pub. Date: Sep. 15, 2011

(54) System and Method for a Public Interactive Information Network

(76) Inventors: Roger A. Rowe, New York, NY (US); Sean Bauld, New Canaan, CT (US); Mark Freeland, Brooklyn, NY (US); Tom Touchet, New York, NY (US)

(21) Appl. No.: 13/046,408

(22) Filed: Mar. 11, 2011

Related U.S. Application Data
(60) Provisional application No. 61/313,379, filed on Mar. 12, 2010.

(51) Int. Cl. G06K 9/68; G06F 3/041

(52) U.S. Cl. 382/218; 345/173

(57) ABSTRACT

A public interactive information network (“PIIN”) that effectively rebuilds and reactivates the public pay telephone system. This network and the interactive information terminal described herein provides many new uses for the public telephone infrastructure including delivery of information and content relevant to the individual citizen in real time at the citizen's location. The terminal replaces a pay telephone in any booth or kiosk. A touch screen and a processor controlled by a main program and a suite of software applications stored in the terminal responds to user selections to provide the interactive access to information. The terminal automatically switches between passive and active display modes and receives user selections by touching the display.

### CROSS REFERENCE TO RELATED APPLICATIONS

The present application claims priority to U. S. Provisional Patent Application Ser. No. 61/313,379 filed Mar. 12, 2010 by Roger A. Rowe, Applicant, and entitled SYSTEM AND METHODS FOR A PUBLIC INTERACTIVE INFORMATION NETWORK.

### BACKGROUND OF THE INVENTION

1. Field of the Invention

The present invention generally relates to communication networks and more particularly to replacing the pay telephones in the public telephone network infrastructure with interactive information terminals using touch sensitive display screens to provide location- and time-specific information free of charge to citizens moving through public spaces.

2. Background of the Invention and Description of the Prior Art

The well known public switched telephone network (“PSTN”) has been a ubiquitous presence for many decades, providing easy access to telephone services to the majority of the population. Though primarily intended for individual customers, businesses, and government entities on essentially a private basis, where each telephone instrument was uniquely identified and addressed by a unique ten digit telephone number, the PSTN system has long been supplemented by a system of publically located pay telephones installed in booths or kiosks at numerous locations convenient to persons traveling or walking and away from their fixed telephone in their office or residence. An example of this prior art apparatus appears in FIG. 1A, which illustrates a standard pay telephone 10 installed on a panel 12 in a booth or kiosk 14.

With the advent and widespread use of mobile telephone services and hand-held instruments, principally serviced by the cellular telephone systems, the use of the public telephones has sharply declined as a convenient means of individual communication, leaving an extensive infrastructure little used and seldom updated with current technologies so that they could compete with other services for revenue.

In the past twenty years the explosive growth of the Internet has vastly increased the availability of information and expanded the influence and reach of media into everyday life by utilizing networks of computers to deliver information and content to anyone with a computing device that is addressable through the Internet. In recent years the widespread adoption of wireless hand-held computing devices has brought telephone-like convenience to the Internet such that a wide variety of two-way communication and interactive services has become commonplace.

Yet, many individuals do not have cellular telephones or mobile hand-held devices. The cost of these devices and the accompanying services is often substantially greater than ordinary telephone service; thus persons of limited means or limited need for such full-featured communication services are left without the ability to utilize the Internet or media content in a practical, low cost way. Further, persons traveling often have a need for current information that is specific to their present location at some point in time. Examples include information about products and services available in the vicinity, public service and safety information or alerts, transportation schedules and charges, entertainment venues, schedules and ticket information, and the like. Conventional methods of providing such information include newspapers, billboards, oversize video screens, handouts of flyers, etc. Information provided by these methods is typically out of date by hours or days, is geographically irrelevant to the person having the need for the information, lacks insufficient detail, and in particular lacks any provision for interacting with the information or its conveyor, etc. Moreover, these conventional methods lack the ability to place a call to an information provider or respond to emergency needs by requesting assistance of public safety providers.

### SUMMARY OF THE INVENTION

Accordingly, the present invention provides a system and methods for a public interactive information network (“PIIN”) that in one embodiment effectively rebuilds and reactivates the public pay telephone system. This new network and the interactive information terminal described herein provides many new uses for the this now dormant public telephone infrastructure to include the delivery of information and content that is relevant to the individual citizen in real time at the location of the citizen. By replacing the coin operated telephone with a touch sensitive display controlled by appropriate software and firmware, adding multimedia processing, and upgrading the transmission lines of the public telephone network, the system is transformed into a PIIN, able to deliver a great variety of new information and interactive media services directly to individuals on the street at a time and place where the need for them is immediate.

In one embodiment an interactive in formation terminal comprises a touch sensitive display screen configured to be installed in a fixed support and connected to electrical power and a network connection, and a processor controlled by a main program and a suite of software applications stored in the terminal and operative in the communication terminal to respond to user inputs and selections via the touch sensitive display. When the display screen is touched by a person, the communication terminal automatically switches between a passive display mode, typically running a sequence of still or video images, and an active display mode that presents interactive options for information to the person who touched the display.

In several other distinct aspects, the interactive information terminal includes a main program operatively coupled to and accessible by the processor for managing the touch sensitive display including display of images and response to the user's touch commands; a web browser accessible via the processor when a menu button is selected by a user's touch; an internal web server operable with the main program to respond to a user selected menu button by calling an application associated with the selected menu button; and a virtual keyboard coupled with the main program and operable in response to calling an application such that alphanumeric entry of data may be accomplished by touching symbols arrayed on a displayed image of the virtual keyboard on the display.

In another embodiment a public interactive information network comprises an infrastructure linking a plurality of interactive communication terminals disposed at corresponding designated public locations into a public network, each supported upon a fixed support having electrical connections to a source of power and to the network. Each interactive communication terminal includes a touch sensitive display screen and a processor controlled by a suite of software applications and operatively coupled to the display of the communication terminal for displaying information and responding to citizen requests or inputs with additional information that is specific to the location, time, and subject matter of the displayed information. The communication terminal automatically switches from a first passive display mode to a second active display mode merely by touching said display screen.

### BRIEF DESCRIPTION OF THE DRAWINGS

FIG. 1A illustrates a diagram of a pay telephone installed in a kiosk or booth as an example of the prior art;

FIG. 1B illustrates a diagram of a first embodiment of a public interactive information terminal according to the present invention as installed in a payphone configuration;

FIG. 2 illustrates a view of the display regions of one mode of operation of the public interactive information terminal of FIG. 1B;

FIG. 3 illustrates a view similar to FIG. 2 but of a second mode of operation of the public interactive information terminal of FIG. 1B;

FIG. 4 illustrates a view similar to FIG. 3 but with the upper and lower regions of the display image inverted;

FIG. 5 illustrates a block diagram of the structure of the public interactive information terminal of the present invention;

FIG. 6 illustrates a block diagram of one embodiment of a system utilizing the present invention;

FIG. 7 illustrates a first example of use of the public interactive information terminal of the present invention to obtain information;

FIG. 8A illustrates a first portion of a second example of the public interactive information terminal using facial recognition technology to validate an account;

FIG. 8B illustrates a second portion of the example of FIG. 8 of using facial recognition technology to validate an account;

FIG. 9A illustrates a first portion of a third example for using the present invention to send a video postcard;

FIG. 9B illustrates a second portion of the third example of sending a video postcard using the present invention;

FIG. 10 illustrates a fourth example of providing a coupon using the present invention; and

FIG. 11A through D illustrates four examples of a display image that may appear in a region of the display of the public interactive information terminal for attracting the attention of a potential user.

### DETAILED DESCRIPTION OF THE INVENTION

### Introduction

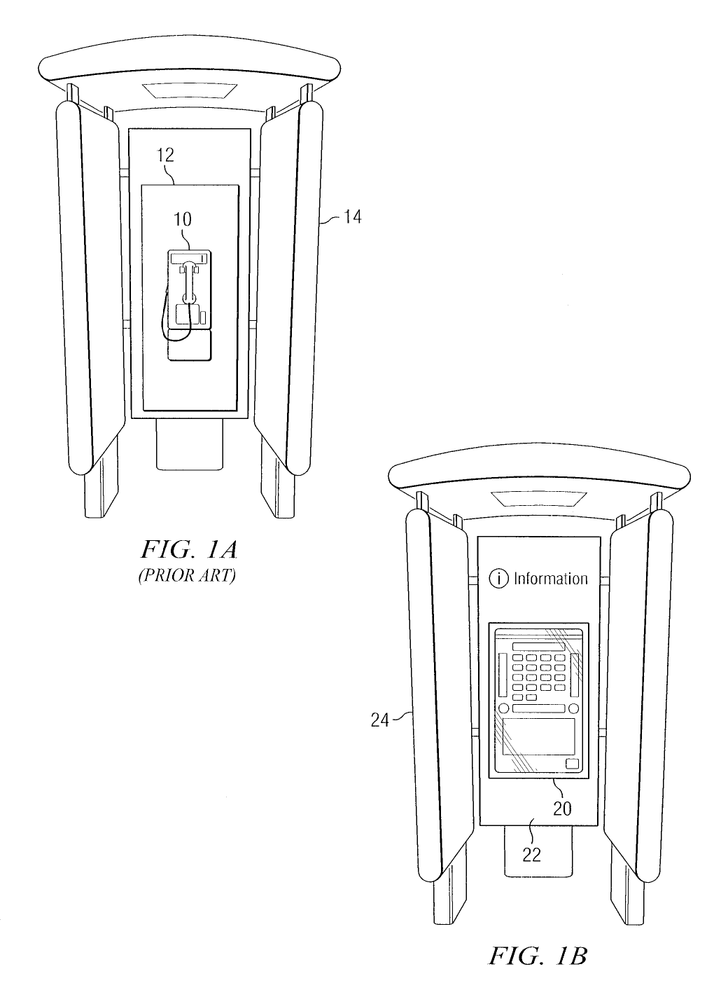

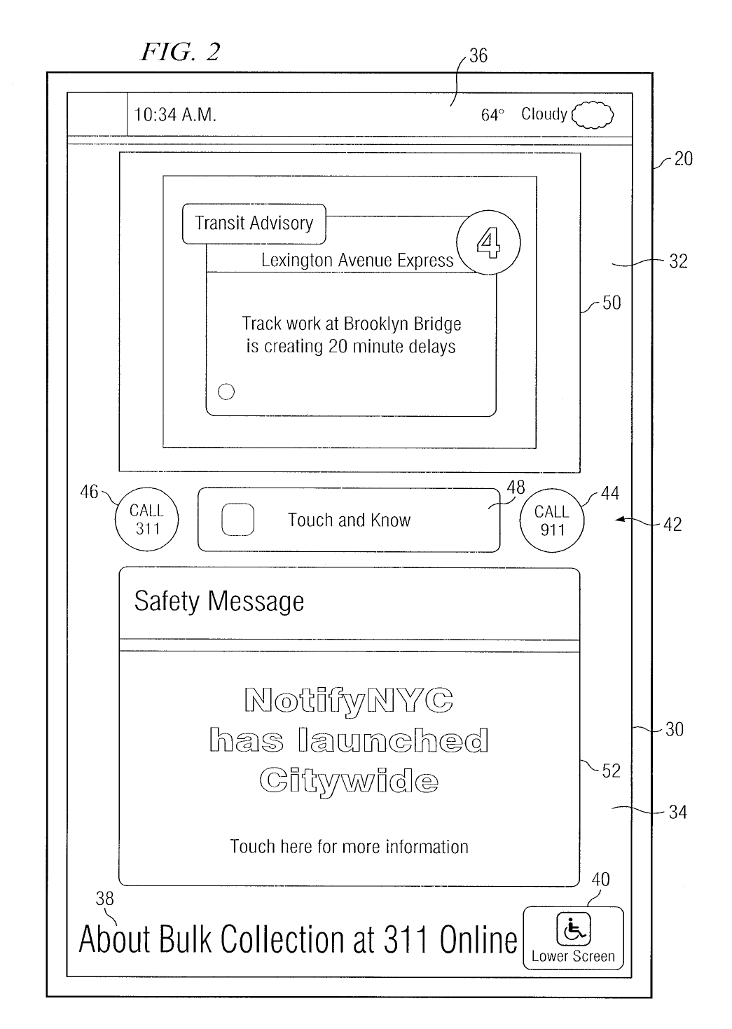

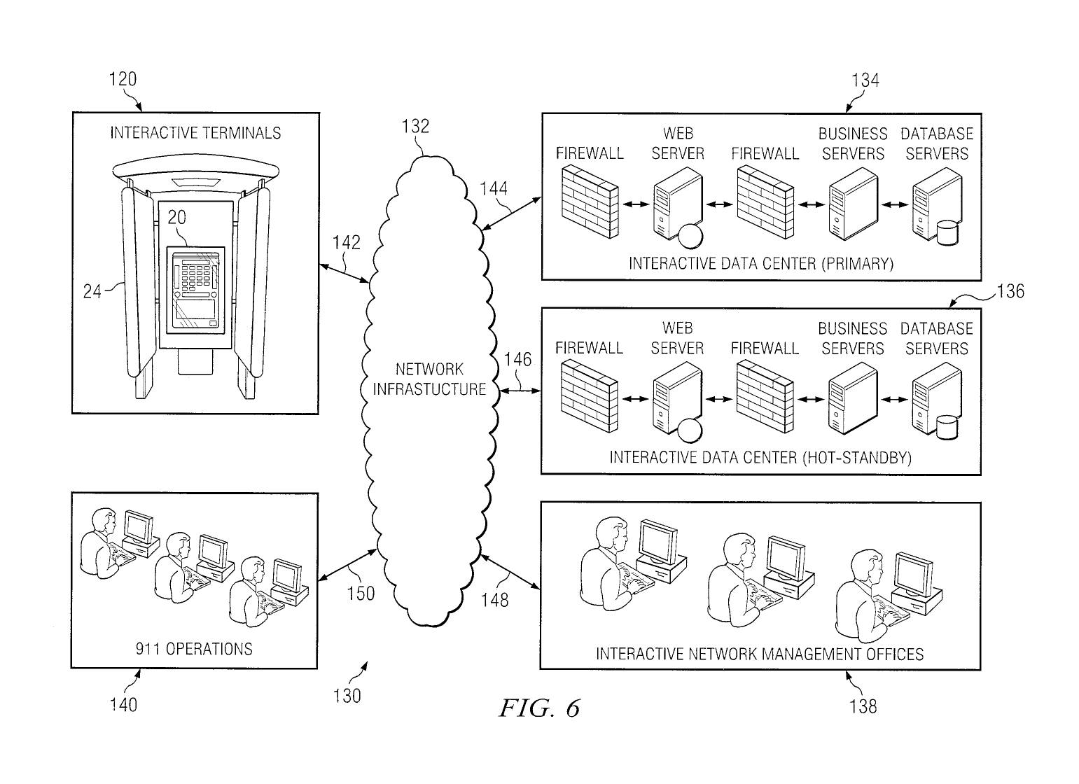

Following this introduction and an overview of the present invention is a detailed description of the principle features of the invention, illustrated in each of the FIGS. 1 through 11. The term “City24/7,” which appears in some of the description to follow, is the name of an entity formed by the inventors to implement their invention of the PIIN 130 and the public interactive information terminals 20 for use in the PIIN 130 described herein. FIG. 5 illustrates in block diagram form the structure of an interactive information terminal 20 according to the present invention. In the description that follows, while the public interactive information terminal may also be referred to as a “terminal,” it will be understood to mean “public interactive information terminal.”

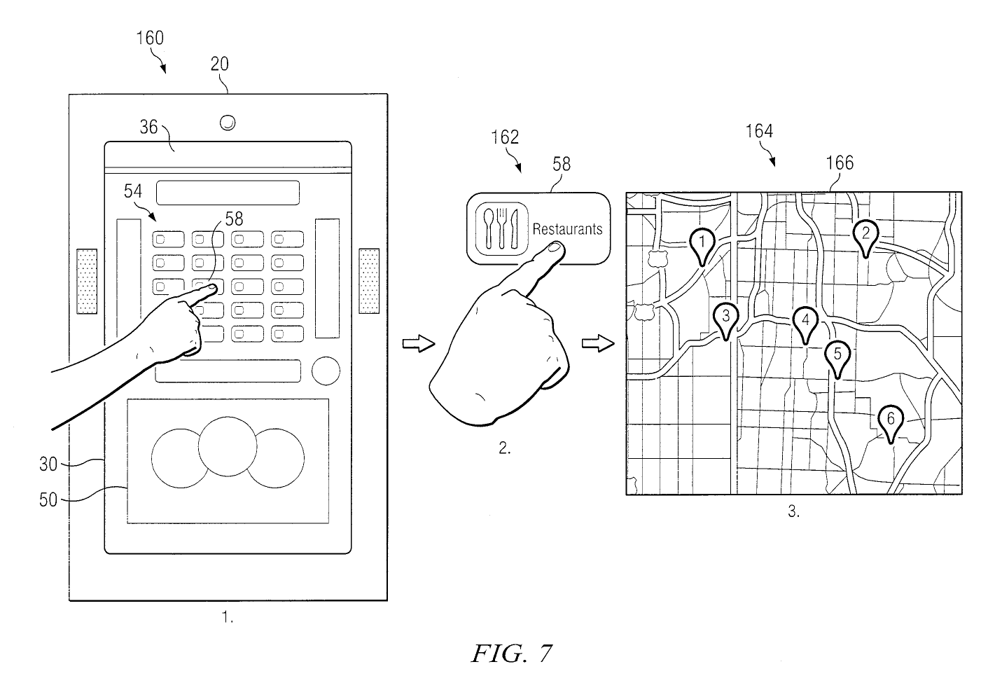

FIG. 6 is illustrative of the system that makes use of a public (pay) telephone infrastructure 132 to provide the public interactive information network 130 or PIIN 130 of the present invention. The interactive information terminal screens (e.g., designated “City24/7” or “i Information” Screens) are each a touch sensitive display 30 that is connected to the network 132 shown in the cloud symbol in the center portion of the diagram. The network 132 in turn is connected to one or more interactive data centers 134 containing a plurality of servers which may include a web server, a business server and a database server. Firewalls may be interposed in several positions among the servers within the data centers 134. Other office systems 138 may be connected to the network 132 to facilitate operations, management, and control. 911 and 311 dispatch centers may also be connected through the network 132 to the terminals 120 to handle citizen requests for assistance. The combination of the network 132 and the plurality 120 of the terminals 20 connected to it comprise one embodiment of the invention and is properly termed the Public Interactive Information Network 130 or PIIN 130. The public interactive information terminal 20 itself, which contains a novel combination of features necessary to implement the PIIN 130, is another embodiment of the present invention.

The basic concept of the invention is that an interactive information terminal, including a touch sensitive display screen and associated hardware and software, is installed in place of a standard pay phone in the public telephone network, converting each such location to an interactive information terminal. Existing network infrastructure (including AC power and the telecom line system, etc.) and its operations may be upgraded as needed to handle the bandwidth and processing required to implement the new uses of the system. The display may be mounted on a wall in place of a pay phone, or in a “phone booth,” in or on a separate kiosk installed in transportation terminals, along sidewalks, in hotels, restaurants, theaters, athletic stadiums, etc.; anywhere people on foot are found, whether indoors or out of doors.

The interactive touch-sensitive display of the terminal normally operates in a passive mode, displaying preprogrammed information, which may include advertisements, public service announcements, weather information, and the like. The information may, for example, be looping through a continuous predetermined sequence of either static or video images. When a citizen or user touches the screen, as prompted by a legend on or near the display, the display enters an active mode that enables the citizen or user to interact with the display—and in fact the Interactive Terminal system—to receive information, respond to queries, enter requests, etc. After the operation in the active mode, the interactive terminal returns, usually after a timed interval, to the passive mode of operation. As in broadcast television e.g., “commercial television” and a number of Internet services, the system may readily be funded by advertising revenue and its service provided to the public at no cost.

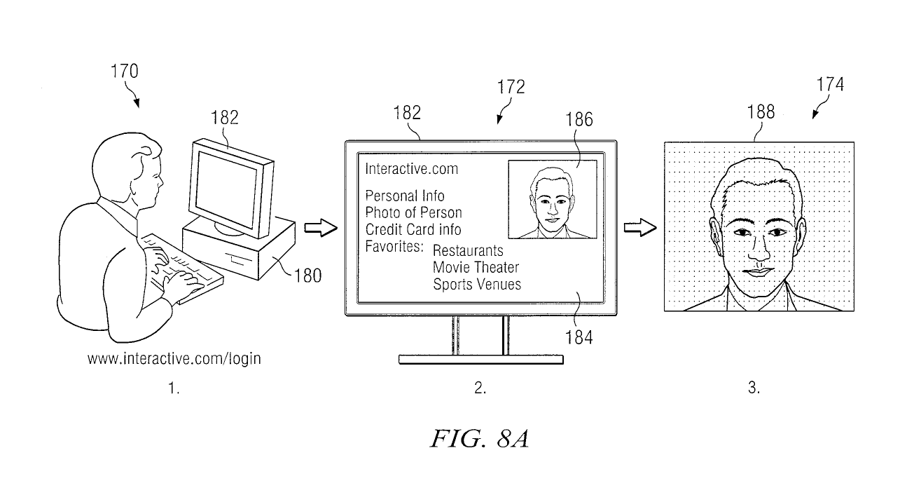

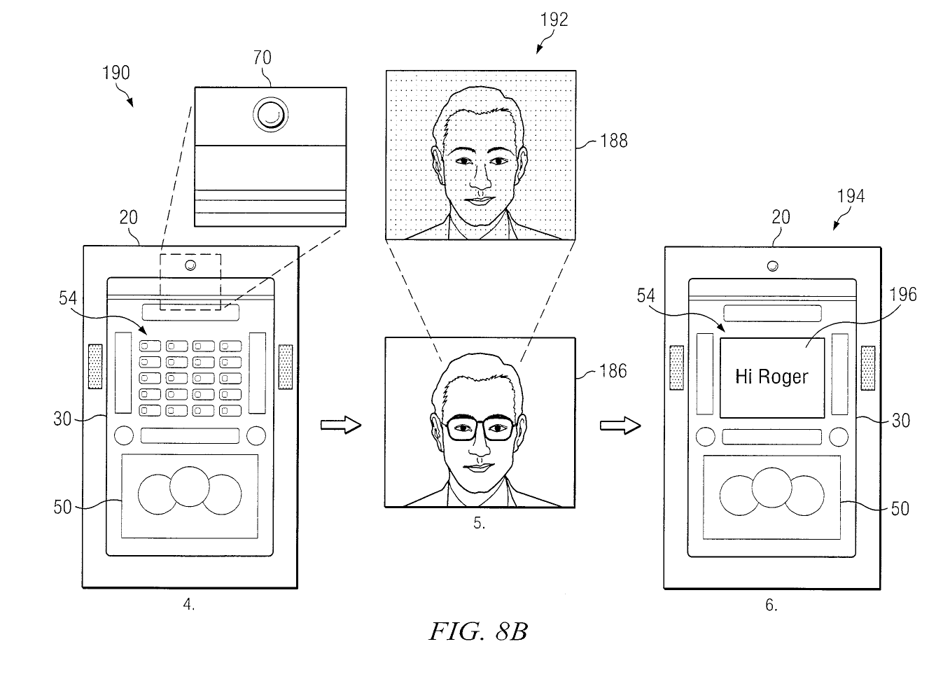

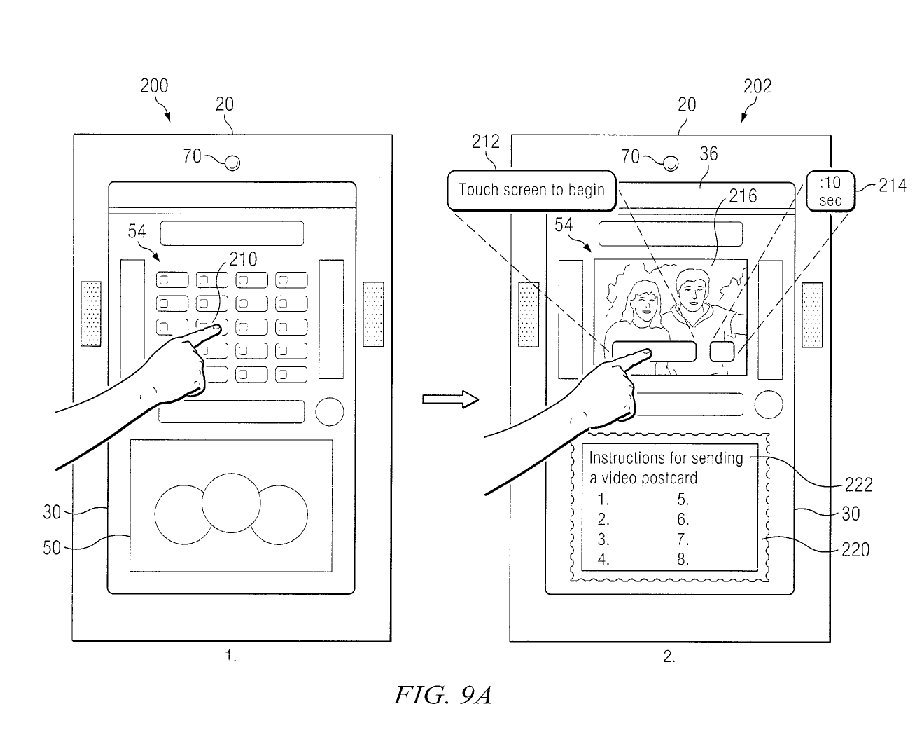

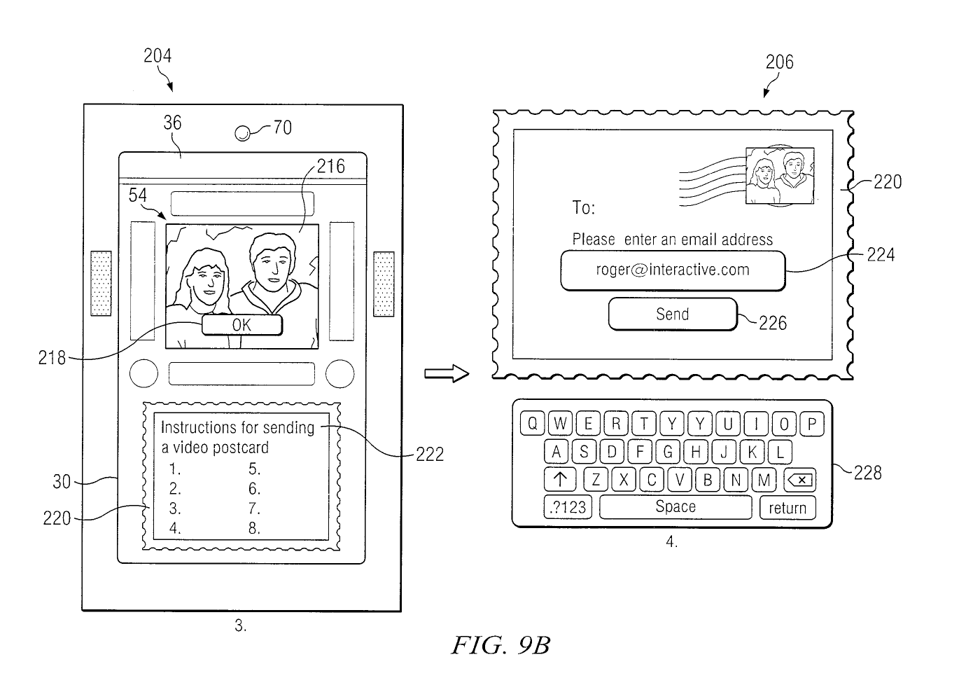

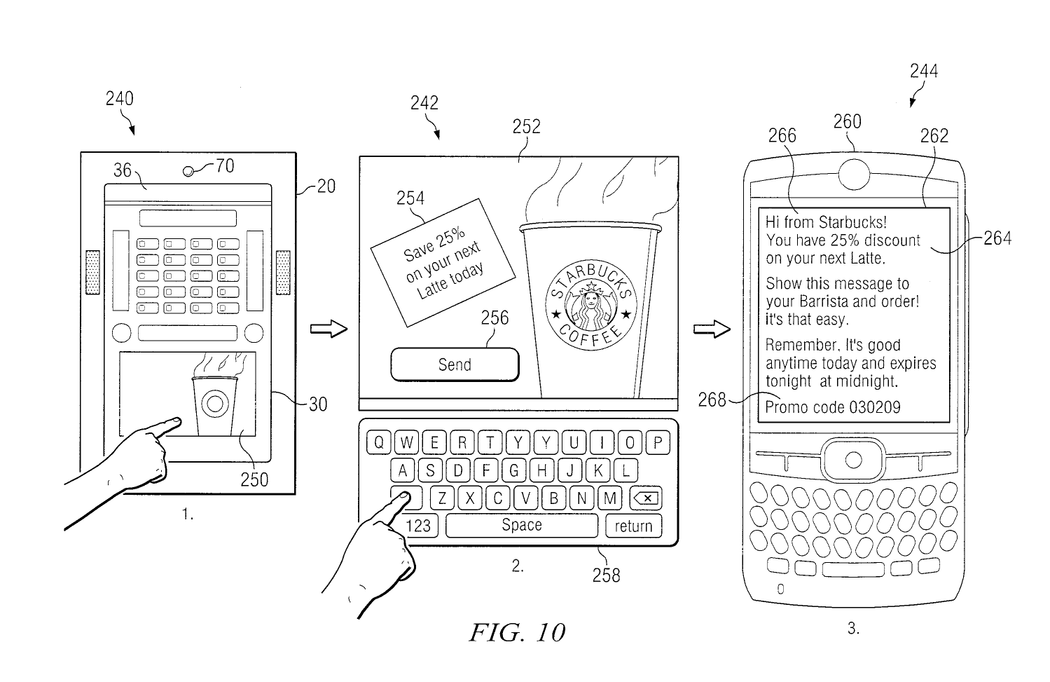

The interactive information terminal network or PIIN described herein includes the ability to perform a number of functions in response to citizen or user actions at the display. From a set of menus a selection of subject matter may be entered by touching a corresponding menu button, followed by the display of advertisements or other information about services or products that are specific to the subject matter, location and time of the request, as shown in FIG. 7. In another aspect, a user may log in to a specific service, be recognized by a camera located adjacent the display and facial recognition software, and directed to the desired site to obtain detailed information or other service, as illustrated in FIGS. 8 and 9. A microphone and loudspeaker may be activated to enable a two-way audio conversation about the information or service that is sought.

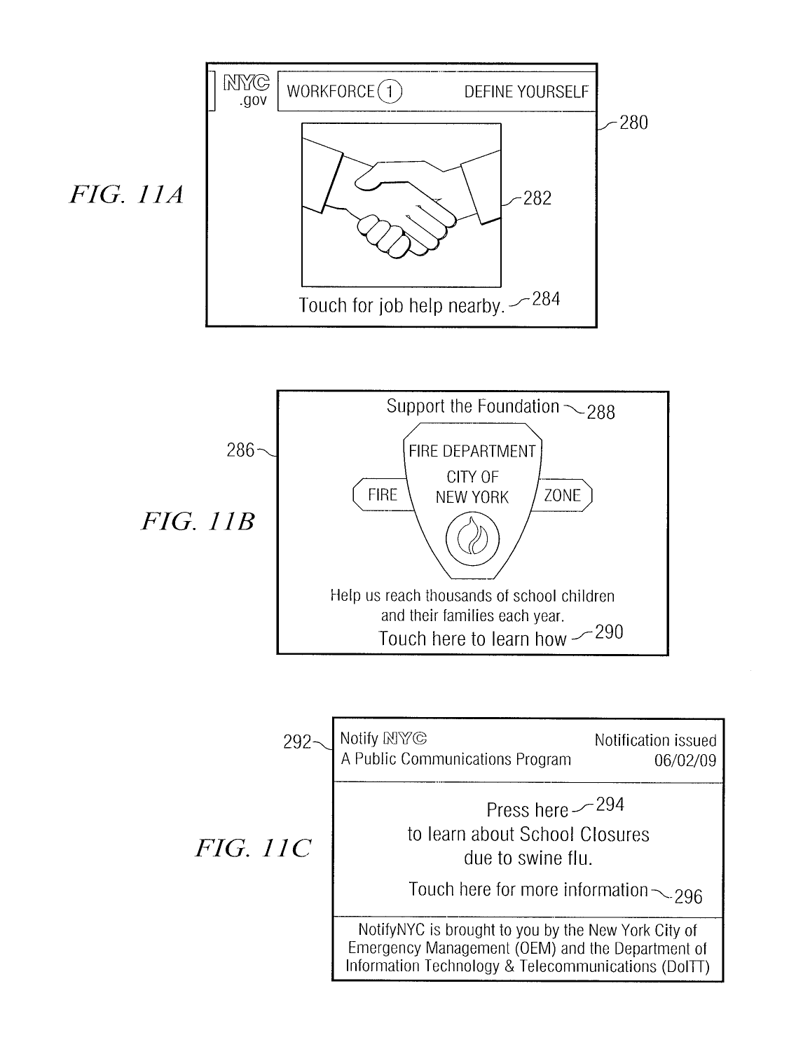

Other functional applications may be provided. For example, a video postcard (see FIG. 9) may be created and sent to a recipient by following a series of prompts as in other applications. The citizen user may obtain coupons or vouchers for discounts by selecting the application described in FIG. 10 from the approach menu displayed on the screen. Still other possible applications include being able to interact with the displayed information or advertisement, to create and interact with a social network, obtain public safety information, report an emergency situation, request emergency assistance, etc.

### Overview of the Structural and Functional Features of the Invention

The interactive information terminal of the present invention may be primarily comprised of off-the-shelf components (ruggedized for outdoor use and protection against vandalism, but otherwise generic), including peripherals to facilitate some of its services. The interactive information terminal of the present invention in combination with the existing telephone infrastructure provides a public interactive information network. The interactive information terminal itself, heretofore not available, combines features in a novel way especially adapted to convert the public pay telephone network to an interactive information system with minimal modifications to the infrastructure of the pay telephone network. The use of a touch-sensitive display enables an ease of use that is simple and intuitive. The peripherals utilized in the illustrated embodiment may include, for example, a high definition (HD) camera, loudspeakers and a microphone. An Ethernet port and a modern, either internal or external may be used to connect to the internet via DSL, fiber (i.e. FiOS), or other broadband protocol.

The system described herein may utilize a standard operating system (“OS,” i.e. Windows, Linux, etc.) and associated application program interfaces (APIs) for basic services, including accessing and manipulating the peripherals, for communicating via HTTP and other TCP/IP based protocols (over the broadband connection, to other computers, typically servers), for managing and running threads and processes, and for providing communication services between and among said threads and processes. Other application framework components included are a web browser (included in the terminal) and an internal web server. Central servers accessible via the Internet may also be utilized through communication links for services and content information.

The software architecture of the interactive information terminal is comprised of the following components to provide the unique capabilities not previously available in a ubiquitous public system accessible to any person who approaches the screen of the terminal:

A main program manages the screen and interacts with the user. This application also directs other software components such as a Windows Media Player or other video renderer to display videos, and Internet Explorer or other web browser to display web-formatted content, custom applications, etc.

1. A library of applications for invention-specific tasks, i.e. video postcards, coupons, etc.

2. Data tables describing screen layouts, content to be rendered, and actions to be taken upon user interaction. User action is typically to touch the screen, which is equivalent to a mouse click.

3. A virtual keyboard component for inputting alphanumeric data.

4. An internal web server along with associated servlets and/or server pages to integrate and format content. Some examples include asp, aspx, jsp, and the like.

5. Background programs that provide system management services, such as downloading content and content updates, software upgrades, application activity logging, and maintaining heartbeat connection or synchronization with a server.

6. The applications library and the data tables will be described further in the context of their use by the various components. The other components are described separately in the following sections.

Main program: This program is started when the OS boots or restarts. Further, the main program is automatically restarted by the OS if the main program terminated.

Upon starting, the main program locates a data table. This data table, which describes the initial (“attract”) screen layout and content, may be an XML file, a table in a local database, or any other form of storage that can be readily located and can store structured data, including hard-coding the data within the main program itself.

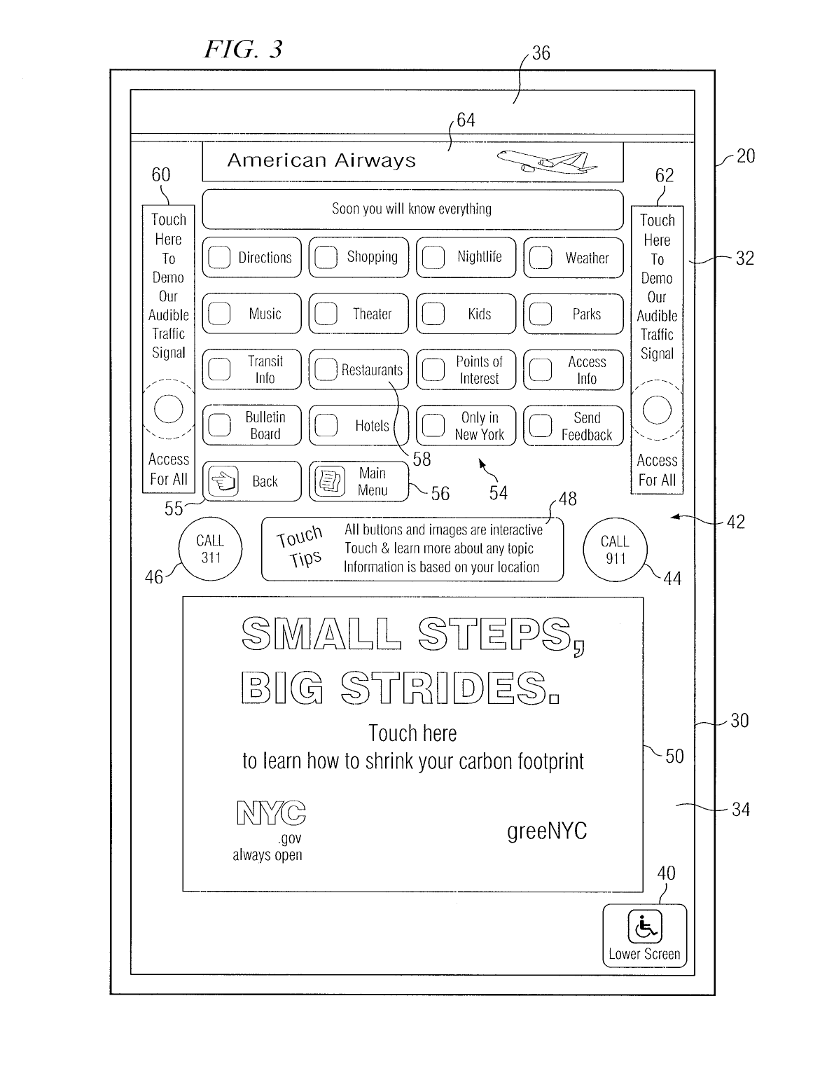

A default background is provided, upon which the main program overlays rectangular regions to build the graphic layout on the screen. Each region is described in the data table—its coordinates, the type of content to be rendered, the source of the content, and the action to be taken upon touching the screen. As noted, touching an item displayed on the screen of the terminal produces the same result as positioning a cursor over the item and clicking a mouse thereon. A present implementation of the “Attract Screen” layout may be shown in <FIG. 2>. This screen layout consists of several regions:

(a) A top banner occupies a narrow strip across the top of the display screen. The content for the banner is generated by an application library component. This component continually updates the displayed time and temperature. The time may be supplied from the system clock of the interactive information terminal, which also periodically polls via TCP/IP one of a variety of free web-based weather services. The polling action may include the location of the machine (i.e. geocoded location, zip code, or other location identifier that the weather service is expecting) loaded from another data table within the application. The weather content displayed may then be the current temperature and general condition (cloudy, clear, etc.) at the particular location of the polling terminal.

b) Below the top banner, the remainder of the upper half of the display screen is designated as the upper region. Similarly, most of the lower half of the display is designated as the lower region. The interactive information terminal operates in two modes, passive and active. When a person or a user is not present the terminal operates in a passive mode displaying what will be called an “attract screen” (or “attract page”). When a person touches the display screen, the terminal enters the active mode of operation and switches the display in the upper region from an attract page to a “menu screen” (or “menu page”). Further, during the passive mode of operation both the upper and lower regions of the screen will display an attract page. Typically, during the passive mode, the upper attract page is configured to attract a person to interact or engage with the terminal, and the lower attract page is configured to attract a person's attention to communicate some item of information.

Thus, the attract screen or page has two functions: one to attract a user to engage the terminal for content, and the other to communicate information as a billboard does, though not necessarily to engage the user with the terminal. Thus the type of content may influence whether the Attract Screen will be configured to attract and engage or to attract and communicate. That content may be city services such as job opportunities, interactive transit information, charity or foundation participation information, news headlines with links to customized information, etc. The possibilities to engage users are endless—all that is needed is a tag line on the Attract Screen image and an option for a user to interact with by simply touching the displayed image to access further information or service via a link to another image or website, for example. The system may be designed to keep the user from wandering, to allow browsing only of enumerated pages, and so on. One other property of the Attract Screen is that it is passive until touched, causing the image to switch to an active region to engage the user in interactive functions. In this context, “passive” means that the display occurs automatically according to a playlist, without user action, including sequencing through a series of predetermined images, usually under the control of a timer for each segment of the playlist being run.

During operation of the main program, the attract screen or page region displays video or static image content (i.e. wmv, mov, jpg, gif, etc. files) under control of the renderer associated in the OS for the particular type of content (i.e. Windows Media player for .wmv, etc.). The content displayed is described in another data table, called a “playlist”. This table lists multiple content items, and the duration of the display. For example, it may list three items—a .wmv file to be displayed for 15 seconds, a .jpg file to be displayed for 30, and another video to be displayed for 15 seconds. The main program sets a timer, so that when the time period is up, it can display the next item in the table. When the end of the playlist in the table is reached, the program starts displaying items from the beginning of the table. If a video has a length less than the time allotted for it in the table, the video is replayed until the allocated time is exhausted. If the display is interrupted by user interaction (a touch), then the system may be configured to either resume from that point (by recording its current position in the playlist), or to restart the playlist from the beginning, the next time this layout is used.

c) In the upper region, during the active mode, the menu screen or menu page region functions as a web browser, resident on the Interactive Information Terminal, offering a variety of links to services or information the user desires to investigate. Each link is represented by a button image on the display, which may or may not include an associated icon or legend. Each button is thus a part of a web page that gives the web browser a URL of a page provided by the internal web server (to be described) of the terminal. That web page (authored in HTML, for example) describes the buttons, how they are laid out, and what URL to go to when the button is touched on the screen. The web page is generated dynamically by the internal web server, according to a data table that lists the image to display (e.g., a .jpg or .gif file), the associated URL, the order or position of the button on the Menu Page region, etc.

d) A central region with a static image, currently labeled “Touch and Know”.

e) Images of buttons to the left and to the right of the “Touch and Know” region. In one embodiment there may be included a button for placing a 911 call, another for placing a 311 call.

f) A ticker “crawl” region along the bottom. The main application gets a list of text strings to display from another data table. It concatenates these strings, and invokes an application from the library that scrolls the text across the designated area, continually.

(g) A button image (“Lower Screen”) at the bottom right corner.

### Operation of the Interactive Information Terminal

When the user touches any part of the attract screen, the main program detects this event, identifies the region touched, and displays a “menu page”. As with the attract page, the layout and content of the menu page is determined by a data table. However, some or all of that page may be altered depending upon the section of the attract page screen that the user touched to get to the menu page.

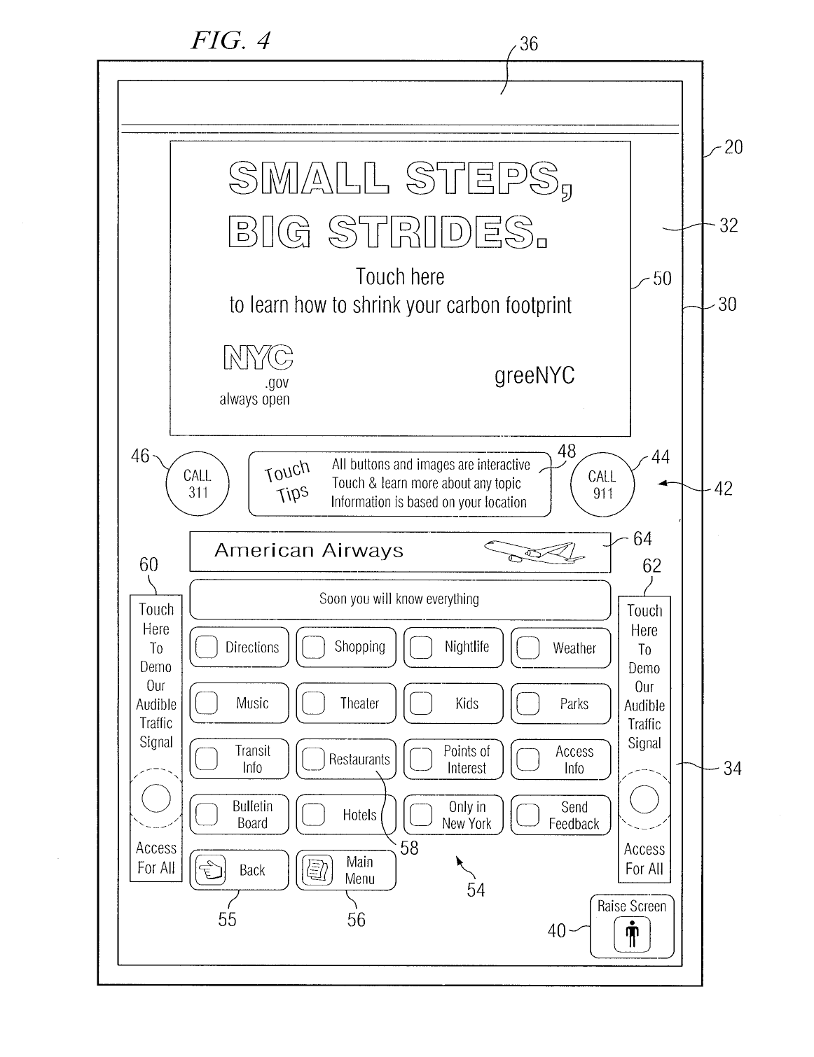

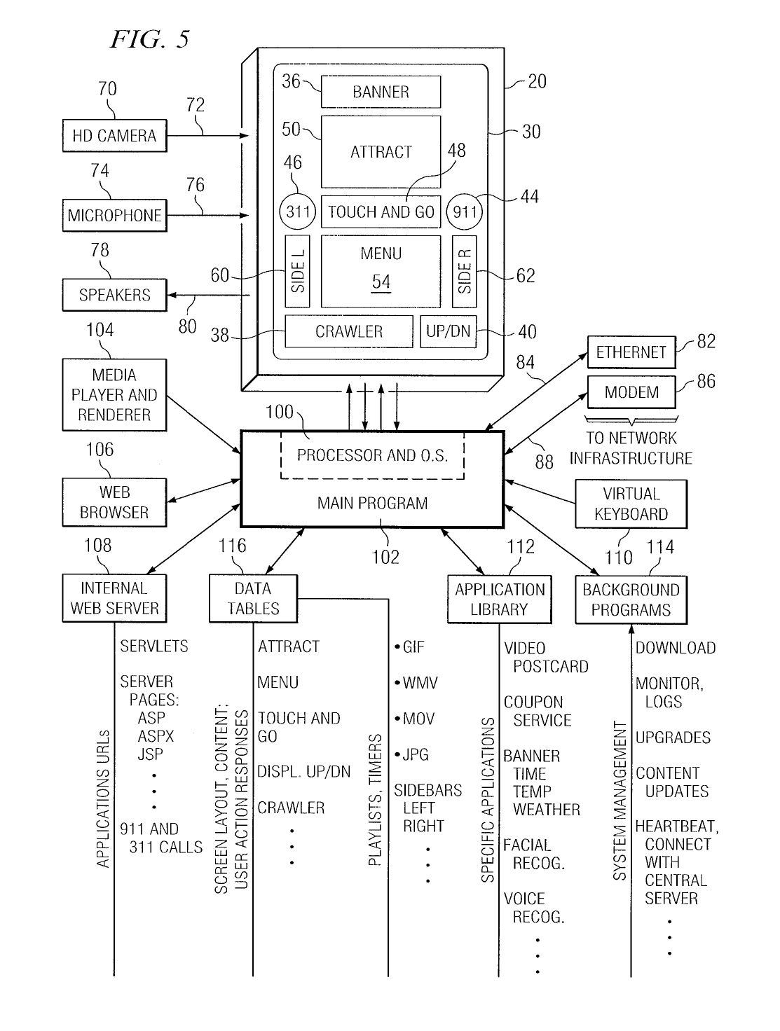

By default, in the illustrated embodiment, the user sees the menu page layout shown in the upper region of FIG. 3. The horizontal banner region along the top, and the vertical rectangular regions along the sides of the menu page region are driven by their own data table playlists, and may cycle through a set of static images enumerated in their corresponding playlists. This menu page region of the screen is a web browser. The other principal region of the screen is the lower display region displaying content that is simply a continuation of the attract screen playlist. The button image at the lower right portion of the screen, for inverting the upper and lower regions of the screen display. The button shows “Lower Screen” when the upper region is an attract page or a menu page as in FIG. 2 or 3, and “Raise Screen” when the lower region is a menu page as in FIG. 4.

Touching the attract screen is the only basic user action required for initiating interaction with the terminal of the present invention. Other user action s provided for are equally simple, and vary according to the particular application of the services provided by the terminal. For example, if the user touches a region displaying content from a playlist, and if the data table describing the playlist associates a URL with that item in the playlist, then the main program starts the web browser, directing it to the designated URL.

If the user touches a 311 or 911 button, then the main program starts the web browser pointing at a local (within the terminal) URL for an internal server-side application that handles the telephone call. The operation of internal server-side applications are described in the section dealing with the local web browser in paragraphs to follow.

If the user arrives at the menu page by touching the “Lower Screen” button, then the top and bottom sections of the screen are reversed, so that the web browser—the menu page showing the menu buttons—is in the lower half of the screen as in FIG. 4. Otherwise, the functionality and layout are the same.

Upon reaching the menu page, different regions of the screen respond differently. If any playlist-driven region is touched (i.e. the rectangular regions on the left and right sides and top of the web browser “menu page” region), the application notifies the web browser that it is to launch the URL associated with the particular item in the playlist being displayed. The menu page is not redrawn, because it is already being displayed.

If the user touches a section (i.e., a particular button) of the web browser in the menu page region, then the web browser reacts to display the web page that is associated with that button. That is, if the user touches an active (linked) section, the browser will react as if the user had double-clicked the item using a mouse pointer to follow the link.

If the user touches the “Lower Screen” button, the application will invert the top and bottom portions of the screen, much as it does when the same button is touched on the attract screen. If the screen is already inverted, then the button displayed in the lower right is designated a “Raise Screen” button, that will again invert the upper and lower portions of the screen, thus restoring the default layout displaying the attract screen in the lower region.

When the menu screen or page is displayed, the main program sets a timer. The timer is reset each time the user touches the menu page. The duration of the timer is contained in a data table. Should the timer go off before being reset to its original period, the application displays a dialog box, asking the user if the user wishes to stay on the menu page. Unless the user responds affirmatively within a period of a few seconds, the main program returns to the attract screen, and resumes the playlist renderings as described.

### Virtual Keyboard

The web browser is instructed to display a virtual keyboard in a separate window whenever the browser's “focus” or attention is directed to a text input area, and to close that window when its attention is removed from a text input area. One implementation of a virtual keyboard is shown in FIG. 10. In this implementation, touching a numeric (.?123) key switches from an alphabetic keyboard to a numeric one, and touching an alpha (ABC) key switches from a numeric keyboard to an alphabetic one.

Web pages that are designed specifically for this invention generally include a single user input box, and are designed so that when loaded and displayed in the browser, the browser “focus” or attention is directed to that input box awaiting input entered with a virtual keyboard that appears automatically on the display screen. Such inputs are used for services like “get directions” (to input the destination address), or “send coupon” (to input a cellphone number to which to text a coupon code for example).

### Internal Web Server

Most of the application services are delivered via the web browser, and are provided by an internal web server. This internal web server, like the main program, is started with the machine, and is continuously running.

In operation, the browser renders implementation-specific pages that display buttons offering the user various services available on the interactive information terminal. When the user touches one of these buttons, the browser follows the URL associated with that button. This URL is an address of a local server-side application. The current invention implements some of these applications as ASPs, others as external CGIs. These are only some of the possible implementations. Architecturally and functionally, they all work similarly. By way of illustration but not limitation, several of these services, including establishing and using a user account, creating a video postcard, and obtaining a coupon will be described. Other applications may be implemented in similar fashion as will be apparent to persons skilled in the art.

User Account: The user requests the service by touching the appropriate button. The button references an internal URL, causing the internal web server to run an application to capture a screen or other image. The web server may call an application to capture a voice recording generated by digitizing and recording the user's voice audio picked up by a microphone in the terminal. In the process of setting up and using an account for facilitating transactions of a user, the system may employ facial recognition and voice recognition applications embedded in the terminal. These applications form digital files of the respective images based on the camera or microphone signals input by the user to establish and verify the user's identity, enabling convenient access to interact with the account. Then, when a user with an established account approaches within range of the camera or microphone of the terminal, the user's visual or audio image may be detected, digitized, and compared with the stored file to determine identity and authorization to access the account.

Video postcard: The user requests the service by touching the appropriate button. The button references an internal URL, triggering the server to run an application that captures a camera or screen image, builds a web page containing that image and present a variety of options, including buttons for zoom in, zoom out, input email address, and send. The camera may be mounted near the upper periphery of the interactive information terminal, for example. As an alternative, an input device may be provided for entering a file from a digital camera of the user. Depending upon which button is pressed, the browser goes to another internal URL to access control parameters as appropriate, i.e. level of zoom, brightness, etc.) to adjust the image if the user requests, and constructs another web page. A template or choice of templates may be provided to compose or format the postcard layout, including placement of the captured image. This process continues until the user is satisfied or abandons the process (via a cancel button). When the user is satisfied, the user touches an “OK” button and the process advances to an address text input box. The virtual keyboard appears and the user inputs the destination email/cellphone address. Upon touching a send button, the postcard is on its way. The server delivers the postcard in the same manner as it delivers coupons, via an SMTP connection. A file sent via the SMTP connection may be received by a device of an addressee such as a printer or video display.

Coupon service: A user may navigate to a web page promotion offering a coupon (i.e. by touching a playlist ad that causes a coupon promotion to be displayed in the browser). This page may reside either on the advertiser's server, or may be integrated with the invention and reside on the terminal. If the page is on the advertiser's server, when the browser brings forward an input box, the virtual keyboard appears, the user is prompted to enter the necessary contact information (i.e. cellphone number or email address), and the advertiser's server generates a coupon and sends it according to its programming.

If the web page is on the terminal, then the internal web server delivers the page to the browser. The user inputs the requisite contact information as already described, and touches a submit button. The internal web server functions much the same way as the advertiser server does: it generates a coupon code according to advertiser-specified rules (i.e. encoded with time and location, consecutively generated, etc.), opens a network connection to an email (SMTP) server, and writes the coupon and destination (appropriately formatted) to the server to effect delivery.

### Background Programs

A variety of background programs are provided in the interactive terminal to manage operation of the main program, internal web server, etc. as well as communication with external or central servers to perform basic management functions. With the exception of the background generation of content, the background processes and centralized server operations may be conventional network management/logging systems. In one example, every several minutes (at a frequency that is configurable and stored in another data table), one program may open a TCP/IP connection to a server at a designated address (internet address and port) and asks a listener on the server whether there are any updates of content. These updates may be changes to the data tables, new web pages (videos, images, ASPs, etc.), or any other data. After appropriate handshaking, the background process downloads the files, installs them in the correct locations, and signals the main program to reread some data files. The external or centralized server keeps track of the last download, so that each time it is contacted, it can tell each terminal just what is new and needs downloading.

Another program (or the possibly the same one, depending upon particular implementation) may contact a centralized server just to demonstrate that it is alive. The centralized server records this “heartbeat”. It maintains a running log of heartbeats (in a circular log so that logs do not persist forever). The centralized server periodically checks the end of each terminal's log to see whether a heartbeat has been missed. The action it takes depends upon configuration—it may wait until a few heartbeats are missed and then send email, it may raise warnings immediately.

Some content may not conic from the centralized server. For example, the content for the text crawl on the Attract Page may come from a Really Simple Syndication (“RSS”) feed. A background process periodically reads the RSS feed designated (in a data table) for the terminal. It parses out the top N items, and reconstructs the playlist for the text crawl. The next time the main program returns to the attract page, it sees the new playlist, and the new text is rendered.

There are also background processes that “listen” for connections from the centralized server. These may be used to force a shutdown or restart, or to update content immediately (for emergency broadcasts).

### Detailed Description of the Drawings

FIG. 1B illustrates a diagram of a first embodiment of a public interactive information terminal 20 according to the present invention as installed in a booth or kiosk configuration. The booth or kiosk 24 is shown having a public interactive information terminal 20 according to the present invention mounted in and supported by a panel 22 in the kiosk 24. The interactive information terminal 20 is thus accessible to pedestrian traffic passing in front of the kiosk 24. The power and signal lines (not shown) of the station may preferably be connected to existing electrical power and telephone line infrastructure receptacles (not shown) to enable their respective functionality. In effect, the public interactive information terminal 20 may be substituted for a standard pay telephone instrument at any public pay telephone installation simply by replacing the pay telephone and its panel with the public interactive information terminal 20 and its panel 22 and making the appropriate power and signal connections to the sources of electricity and the telephone line infrastructure. While the standard pay telephone, limited to providing ordinary telephone service, the public interactive information terminal 20 is capable of providing a wide variety of interactive information services that may be made available simply by viewing the display and/or touching the display screen of the terminal 20. In addition, no deposit of coins or currency is required of the user to engage with and interact with the terminal 20.

FIG. 2 illustrates a view of the display 30 in one mode of operation of the interactive information terminal 20 of FIG. 1B. The display 30 (or alternately, screen 30) is partitioned into two major defined regions, an upper region 32 and a lower region 34. Above the upper region 32 is a banner region 36 formed as a horizontal strip across the top of the screen 30. The banner 36 may include time and weather information such as temperature and a brief forecast at the location of the terminal 20 as shown. Below the lower region 34 is a crawler region 38 formed as a horizontal strip within which a message may be moving (“crawling”) across the screen 30. The message may include, for example, news headlines, an advertising message, emergency warnings or instructions, and the like. In the example shown, a crawling fragment of a message appears “ . . . About Bulk Collection at 311 Online . . . ”

In the illustrated embodiment of FIG. 2, at the lower right corner of the screen is a button image 40 that may be used to invert the images being displayed in the upper 32 and lower 34 regions. This button image 40 “Lower Screen,” may be touched to cause the displayed image(s) appearing in the upper region 32 to be interchanged with the lower region 34 so that it is more visible and accessible to a user who is very short of stature or seated in a wheel chair. Located between the upper 32 and lower 34 regions of the screen 30 may be other button images 40 (or “buttons”) or small regions designating particular services that may offer commands to enable the user to affect some action involving the displayed images. Examples of use of buttons in this central region 42 are buttons 44, 46 to place a 911 call or a 311 call, for example, or additional buttons or bars (represented by the bar 48) to enable other options or commands. Examples of commands that may be used with bar 48 are a return to a “home” display or to access further information according to a “Touch and Know” query.

The terminal 20 is operative in two basic modes, a passive mode and an active mode. During the passive mode, which appears when no user is present and interacting with the terminal, FIG. 2 illustrates the screen layout. The image appearing in both the upper and lower regions is an attract screen or page 50. The attract screen 50 is usually displayed in the upper region 32 but a second attract page 52 may also be displayed in the lower region 34 during the passive mode. In the active mode, initiated when a user touches the screen at the attract page 50, the upper region 32 displays a menu page 54 as illustrated in FIG. 3, and the lower region 34 displays an attract page 52. The attract page 52 may or may not be the same attract page displayed in the lower region 34 during the passive mode before the screen was touched. In the passive mode, one or both upper 32 and lower 34 region of the display 30 are typically either a static image or may be sequencing through a series of static images or video segments. The sequencing may be under the control of one or more playlists containing timed content segments, as will be described herein below. Each content segment is generally designed to convey information to anyone within viewing distance of the display 30.

FIG. 3 illustrates a view similar to FIG. 2 except the upper region 32 displays a menu screen 54 representing the active mode of operation of the interactive information terminal 20 of FIGS. 1B and 2. The active mode appears when the display 30 is touched during operation in the passive mode, causing a menu screen 54 (or page 54) to be displayed, usually in the upper region 32 (as shown in FIG. 3). If the button 40 at the lower right corner is touched, the regions of the screen will be inverted as shown in FIG. 4. Thus, touching the screen switches the display from the passive mode of FIG. 2 to the active mode of FIG. 3. Touching most regions of the display during the passive mode causes the active mode menu screen 54 or page 54 to appear in place of the passive mode image in the upper 32 region of the display 30.

For example, when the user touches any part of the screen 30, the main program 102 (see FIG. 5) detects this event, identifies the region touched, and displays the menu page 54. As with the attract page 50 or 52, the layout and content of the menu page 54 is determined by data tables 116 in the datatables (see FIG. 5). However, some or all of that menu page 54 may be altered depending upon the section of the attract page 50 or 52 screen that the user touched to initiate the active mode and get to the menu page 54.

The attract pages, which appear during the passive mode, arc governed by playlists (in the data tables 116 of FIG. 5) that determine the content of the page and its duration in the passive mode loop—a sequence of content segments that repeats unless interrupted by a user touching the screen. Each attract page may include several playlists, one or more of which may also include a URL. Thus, during the passive mode, touching a portion of either upper 32 or lower 34 region having a playlist that includes a URL causes entry into the active mode. Instead of displaying the menu page with its array of buttons, the web browser will display content (from that URL) related to the portion of the image that was touched having a playlist that included the URL. When touched, the screen switches to the active mode (as always) and displays the content from the URL in the upper region where a menu page with buttons would otherwise be displayed.

Shown in FIG. 3 on either side of the menu page 54 in the upper region 32 of the screen 30 are narrow, vertical side panels 60, 62 (designating left, right) that may display ads or instructions to the user. In the example shown an instruction appears in both side panels: “Touch Here to Demo Our Audible Traffic Signal.” In other examples (not shown) these regions of the display 30 may be used for displaying ads for businesses or service providers within the vicinity. This advertising will preferably reflect the user's location, time of day and the user's interaction with the terminal's display 30. Since all terminal (and screen) locations are known because each terminal is initialized with its own location information that it can report as needed, information specific to that location is easily distributed to it. The distribution of information to the individual terminal locations may be provided according to certain priorities set by the network management. Appearing below the array of menu buttons in the menu page 54 are separate buttons for “Back” 55, and “Main Menu” 56. The screen 30 illustrated in FIG. 4 also includes a top banner 36, a central panel 48, the 911 and 311 buttons 44 and 46 (which may or may not appear, depending upon data in a data table 116), and a passive attract page 52 displayed in the lower region 34 of the screen 30. Note that the attract page 52 is determined by its playlist content, which is generally a sequence of images and/or video. If the user desires to invert the major regions, the user may touch the “Lower Screen” button 40 at the lower right hand corner of the screen 30 and the display 30 will appear as shown in FIG. 4 to be described.

Upon entering the active mode and reaching the menu page 54 displayed on screen 30 in FIG. 3, the user may interact with different regions of the screen 30. If any playlist-driven region is touched (i.e. the smaller rectangular regions 60, 62, 64 to the left, right and top of the web browser menu page 54 within the upper region 32), the application notifies the web browser (to be described later) in the terminal 20 that it is to display the URL associated with the particular item in the playlist for the smaller region being displayed that was touched by the user. The menu page 54 within the upper region is not redrawn. Rather, the content of the smaller region that was touched is altered directly according to the URL.

When the user touches a particular button of the menu page 54 region, the web browser reacts to display the web page that is associated with that button. Touching a button redirects the browser to connect to the web site or web page associated with the button that is touched. The act of touching a button has the same effect as clicking a mouse button when a cursor is positioned on the button. In this example of FIG. 3 the buttons may redirect the web browser in the terminal 20 to websites represented by the buttons for Restaurants, Shopping, Nightlife, Weather, Music, Theater, and many others illustrated in FIG. 3. An example of the use of menu pages is described in FIG. 7 herein below. It may be noted that the “Touch Tips” bar in the central region 48 of the screen 30 includes the instruction about the use of the menu page buttons.

In operation, the browser renders implementation-specific pages that display buttons offering the user various services available on the interactive information terminal 20. When the user touches a menu page button, the browser follows the URL associated with that button to an address of a local server-side application. Some of these applications are implemented as ASPs, others as external CGIs. These are only some of the possible implementations. Architecturally and functionally, they all work similarly. By way of illustration but not limitation, several of these services, including establishing and using a user account, creating a video postcard, and obtaining a coupon will be described in conjunction with FIGS. 8, 9, and 10. When the menu page 54 is displayed, the main program 102 sets a timer. It resets the timer each time the user touches the menu page 54. The duration of the timer is contained in a data table 116. If the timer expires, the application displays a dialog box, requesting whether the user wishes to remain in the active mode, engaged with the menu page 54. Unless the user responds affirmatively within a period of a few seconds, the main program 102 returns to the attract screen 50 or 52 in the passive mode, and resumes the playlist renderings as described.

FIG. 4 illustrates a view similar to FIG. 3 but with the upper 32 and lower 34 regions of the display image inverted in response to a user pressing the button 40 at the lower right corner, to lower the menu page 54 within reach of a person of short stature or seated in a wheelchair.

Both upper 32 and lower 34 regions of the screen may display attract mode content during the passive mode that may be a still image or a video segment. The content is a matter of what is entered into the respective playlist (upper or lower). In one preferred embodiment a video sequence is run in the upper region 32 or loop (playlist) and a sequence of still images is displayed in the lower region 34. In either case, according to the playlists in the data tables 116, sound may accompany the displayed content through loudspeakers 78 (See FIG. 5) installed in the terminal 20. sound may also accompany content during the active mode. The system prioritizes the sound when two regions of the screen both contain sound content.

Each playlist is a list of content and the duration of time the content will be displayed or the video segment will run. The duration of a video segment may be the same as its length or a truncated version of it, or if the segment is repeated, the duration allowed for that content will be longer than the length of the segment. Each content item in the playlist for the upper region 32 may also have an attribute that determines whether it is to be displayed on the entire screen 30 and not just one of the regions. For example, if this attribute set for an item, the item is displayed in full screen format for its duration, in effect, “covering” the lower region 34 display, which may still be running but not seen. In other words, when the user goes to a menu screen 54 in one of the regions 32, 34, the other region 34, 32 continues to run. When a subsequent item in the playlist for the upper region 32 does not have this “full screen” attribute set, it is displayed in the upper region 32, and the lower region 34 is “uncovered.” Thus the playlist that had been running in the lower region 34 is again visible, and is displaying content as though it had never been covered.

FIG. 5 illustrates a block diagram of the structure of the interactive information terminal 20 of the present invention. At the top center of the figure is a pictorial representation of the interactive information terminal 20 illustrating the regions of the display 30 outlined thereon as previously described. In the illustrated embodiment the terminal 20 may be configured as a rectangular chassis or housing 18 that includes the touch-sensitive display 30 and all of the components of the interactive information terminal 20 as shown in FIG. 5. Just below the terminal 20 is a processor 100 with its operating system (OS) and a main program 102 stored in the processor's memory (not shown). Note that the reference number 100 applies to the combination of the processor and its operating system. Alongside the terminal 20 are several hardware components which may be included in the terminal structure, such as a high definition camera 70 (HD camera), a microphone 74, loudspeakers 78, an Ethernet Interface 82, and a modem 86. The HD camera 70 is coupled to the terminal 20 via a link 72, the microphone via a link 76 and the loudspeakers via a link 80. The Ethernet Interface 82 and the modem 86 are similarly coupled to the processor and O.S. 100 via respective links 84, 88. In an alternate configuration, the modem 86 may be coupled indirectly to the processor on O.S. 100 by using line 88 to connect via the Ethernet Interface 82. The remaining boxes identify software components of the terminal 20. These include a media player and renderer 104, a virtual keyboard 110, a web browser 106, an internal web server 108, background programs 114, an application library 112, and various data tables 116. In the figure each of the last four components named above includes a list of separate software programs, playlists or data as shown that may be accessed by the main program 102 from these software components as needed. These lists are intended to be illustrative and riot limiting. Persons skilled in the art will realize that many other playlist combinations are possible.

Each of the hardware items may be off-the-shelf items found to be suitable for the application as may be readily determined by persons skilled in the art. Some of the software components are off-the-shelf items others may be custom written for the present invention that contribute to the novelty of its functioning, including the comprehensive interactive features built in to provide the convenient access to a wide variety of information and services unavailable in any other single system. The novelty of the present invention lies in the combination of elements assembled together to perform the unique functions described herein. The concept of the invention relies on the insight to utilize the existing pay phone infrastructure to form a network of public interactive information terminals that embody numerous unique and convenient information services that are usable anytime by anyone merely by approaching a terminal and touching the screen's display surface.

Continuing with FIG. 5, the high definition camera 70 may preferably be a digital unit and be built into the front panel of the terminal 20 (See, e.g., FIG. 9) to provide digitized images for facial recognition, video postcards, or to provide a view of the vicinity of the terminal 20 in emergency situations. The microphone 74 may likewise be built in to the terminal 20 for use in communicating with a service called up by the user at the terminal 20 or to monitor the audible sounds in the vicinity of the terminal 20. Loudspeakers 78 may provided for issuing audible messages in voice or music or in playback of background music.

Two types of communication interfaces are illustrated for providing connections to the network infrastructure 132 (See FIG. 6) and the Internet or other global communication network: an Ethernet Interface 82 or a modem 86. The technology of these interface components is well understood by persons skilled in the art and need not be described further herein.

The virtual keyboard 110 may be called by an application run by the processor 100 in response to the user's touching a functional command button appearing on the display screen 30. Two versions of the keyboard, alphabetic and numeric, may be provided. In one embodiment, the virtual keyboard contains alphabetic keys, and the user may elicit a keyboard containing numeric keys by touching a designated Shift key. The reverse transition, from numeric to alphabetic keys, may be effected by touching a similarly designated Shift key on the numeric keyboard. The virtual keyboard 110 may be called in either alphabetic or numeric character format by a playlist or an application run by the processor 100 in response to the user's touching a functional command or button appearing on the display screen 30. For example, when a user activates a video postcard or coupon application a virtual keyboard 110 will appear to enable the user to enter identification or other information or an email address for receiving a postcard or coupon. In other instances, a web page will request entry of user information upon the virtual keyboard 110 that appears upon a prompt to the user to enter the information.

The background programs 114 may contain primarily system management and housekeeping applications for downloading content updates or upgrades to other applications, monitoring or keeping activity logs, maintaining the heartbeat synchronization in connections with the interactive data centers 134 and offices 138 (shown in FIG. 6) or other external or central server, etc. The application library 112 may include specific applications for video postcards, coupon services, time and weather information for the banner panel, facial recognition and voice recognition for account identity verifications and the like.

The interactive information terminal 20 of the present invention preferably includes an internal web server 108 that may be called by the web browser 106 to integrate and format content, and to access a particular web site or web page called in response to a user's touch upon the display screen 30, either upon an attract screen 50, 52 (to access a menu page 54) or upon a button (e.g., button 58 among many choices) appearing in the menu page 54. The internal web server 106 may include the URLs to server pages associated with ASP, ASPX, JSP files, etc., various servlets, and 911 and 311 calls, for example.

Serving the applications available in the terminal may be data tables 116 having files dedicated to screen layout, content and user action responses for the content regions: attract pages 50, 52 and menu page 54, the touch and Go Panel 48, the Up/Down button 40 for inverting the upper 32 and lower 34 regions, and the bottom crawler display 38. The data tables 116 may also include playlists and timers for various sequences displayed on the content regions including the attract pages 50, 52 or menu page 54 screens such as .GIF, WMV, MOV, JPG, and the side panels left 60 and right 62.

The software functions are managed by the main program 102. The main program 102 manages the display 30 in the passive and active modes. In the passive operative mode the main program 102 also operates to manage the display of content and other images. In the active operative mode the main program 102 operates to control the response to touching the display at specific image locations on the screen. This response may cause the display to switch between the passive and active modes (corresponding respectively to the attract and menu displays). Or the response may act to redirect the web browser to a particular web page or site when a button image in the menu screen 54 is touched.

FIG. 6 illustrates a block diagram of one embodiment of a PIIN or public interactive information network system 130 utilizing the present invention. The public interactive information terminal 20 may be thought of conceptually as a stand alone replacement for the pay telephone instrument found in numerous public spaces (See, e.g., FIG. 1), usually mounted on a wall or panel 22 in a booth or kiosk 24. Although it is functionally far more versatile than a pay telephone, the interactive information terminal connects to the public telephone infrastructure in much the same way, providing access to the Internet and other entities connected to it. The system 130 illustrated in FIG. 6 may represent the basic functionality of a system in a large municipality such as New York City, for example. An interactive information terminal 20 that represents a plurality 120 of such terminals is shown operatively connected to a “Network Infrastructure 132,” sometimes called a “network Backbone.” The telephone network provided in New York City by Verizon Communications Inc., which provides business class services is such an infrastructure 132.

Continuing with FIG. 6, additional entities coupled or connected to the network 132 in the system 130 via communication links 142, 144, 146, 148, and 150 may include an interactive data center 134 (primary), and a backup interactive data center 136, which provide services such as database management and software to the kiosk locations of the interactive information terminals 120 on a fully redundant basis. Further, the system may include one or more interactive network management offices 138 and one or more interactive emergency response dispatchers 140. The network management offices 138, which may be represented by one or more desktop computers 152, provide operation management and control, and respond to requests from the individual terminals. The emergency response dispatchers, each represented by one or more desktop computers 154 and a voice channel connection (not shown) may for example be a 911 operations center connected via a communications link with the network. Communication among each of these entities along the links 142 through 150 is necessarily two way to enable rapid response and the maintenance of real time services. The two way communications links 142 through 150 may be any suitable channel provided by wired, wireless, or optical technology having sufficient information capacity for the expected traffic. Further, each of the data centers, which contain one or more servers 156 (such as a web server, business and database servers), may preferably include a system of one or more firewalls 158 as shown to maintain adequate data security.

The following comment regarding FIGS. 7 through 11 is provided to the reader. The interactive nature of the interactive information terminal 20 of the present invention is provided by the use of a touch-sensitive display screen. The user engages the terminal by observing its displayed images and if he or she chooses, responds by touching the display screen to select access to information available. FIGS. 7 through 11 illustrate several exemplary instances of a user's interaction with the terminal by presenting a sequence of images and the user's relationship with them. These image sequences are presented in lieu of flow charts often used to describe process steps. Persons skilled in the art will recognize that the sequence of steps is inherent and clearly apparent whether illustrated in flow charts or pictorial sequences as provided herein. To facilitate following the sequence being illustrated, an arrow is shown leading from one image to the next one in the sequence. The images are also numbered 1, 2, 3, etc. to enumerate the sequence being illustrated. The sequences illustrate the steps being performed in the software described herein above that controls and manages the display of the images and their content, as will be readily understood by persons skilled in the art.

FIG. 7 illustrates a first example of use of the public interactive information terminal 20 of the present invention to obtain information. As previously described, touching the display screen 30 will cause the display 30 to switch to a menu screen region 54. The menu screen region 54 is a menu that presents an array of button symbols to the user. Each symbol represents a service available to the user and may be labeled with a name or icon or other symbol. In effect, the menu 54 is page rendered in a web browser; touching one of the buttons calls up a web page of a website. Some of the web pages viewable on the terminal 20 may be supplied by the internal web server 108 while others may be supplied by external or remote web servers via the network 132. In the figure, a user touches a button symbol 58 for “Restaurants” in the first image 160. The touch action is shown enlarged in the second image 162, causing the display 30 to change to the web page 166 in the third image 164 illustrating information about restaurants in the vicinity of the terminal. An initial web page 166 screen may be a map of the vicinity showing the locations of nearby restaurants. Touching a numbered flag symbol 168 on the map display 166 may cause the screen 30 to change to a web page of the restaurant corresponding to the flag symbol 168 on the map to provide further information about the restaurant at that location. Alternate web pages 166 may display menus, images of the restaurant, directions, or facts about the restaurant and its staff, etc.

FIG. 8A illustrates a first portion of a second example of a use of the public interactive information terminal 20 using facial recognition technology to validate an account. In this example an account with the provider of the PIIN, here an entity named “City24/7” for example, may be set up from any computer connected to the Internet by entering the entity's on-line address to its website to create an account. The first image 170 shows a user at a desktop computer 180 equipped with a display 182. The user enters the basic personal information and a photo, which appears on the screen 184 of the display 182 in the second image 172. The photo 186 is depicted on the screen 184. The user may also be given the opportunity to enter preferences for restaurants, theaters, sports venues, or other service providers. The photo 186, in digitized form 188 is shown in the third image 174. The digitized photo 188 and other personal identity and preferences information may be entered into a database of the provider's website that then becomes an access point for obtaining information through verification of the user's identity via facial recognition software.

Software on the provider's website may download the personal information to terminals automatically. In another embodiment, the information may be downloaded automatically only to individual terminals that the user chooses to log into. This effectively keeps the personal information on each terminal at a manageable size while still keeping it cached in terminals with which the user is likely to interact. In such an embodiment, software on the provider's website stores in a database or other data repository a record of the terminals that have downloaded a given individual's data. When a user updates personal data, the provider's website then automatically downloads the updated information to the terminals that had previously initiated downloads of the data for that individual. The foregoing description of downloading information is intended to serve as an exemplar, and is not exhaustive of all protocols for distributing personalized information to the individual terminals in the network.

FIG. 8B illustrates a second portion of the example of FIG. 8A of using facial recognition technology to validate an account. The sequence shown in the fourth, fifth, and sixth images 190, 192, and 194 depicts the experience of the user approaching a terminal. As the user appears in front of the terminal 20 the built-in HD camera 70 takes a photo 186 of the user in the fourth step and processes the photo 186 in the fifth step shown in image 192 using the internal facial recognition technology as illustrated in the second step of the sequence described in FIG. 8A. If a match is detected by the process and other data in the identification database is verified, the terminal 20 displays a message to the user in the fourth step shown at image 194 inviting the user to interact with the terminal 20 in the sixth step illustrated in FIG. 8B (as depicted by the message 196 “Hi Roger”) by accessing the system and making a selection or a request. In one of many possible examples, the user may ask, speaking toward the display 30, which includes the microphone 74 (previously described in FIG. 5): “What movies are playing today?” After the terminal 30 responds by interpreting the user's spoken request with the internal voice recognition software and displaying a list on the screen of nearby movies playing that day, the user may state the name of the movie desired, the number of tickets and the desired show time, and then stating “put it on my account.” The tickets are then paid for using the user's credit card information already stored in his or her account record (as described in the second step of FIG. 8A). Finally, the terminal may send a confirmation text message to the user's phone to redeem the tickets, again using information supplied by the user in setting up the user's account in the second step of FIG. 8A.

FIG. 9A illustrates a first portion of a third example for using the present invention to send a video postcard. The sequence is illustrated in four images numbered 200, 202, and 204, 206 appearing in FIGS. 9A and 9B. To begin the process, a user selects “Video Postcard” from the menu page 54 by touching a button 210 and then may select either the built-in HD camera 70 or an image sent from an external source (not shown). An image file from an external source may be transmitted from a mobile device or from a digital camera for example by following instructions as described herein below and displayed to the user during the process of creating the video postcard upon touching button 210. In this example a photo for the postcard may be formed by the built-in HD camera 70 of the terminal 20 using instructions displayed in the lower region of the screen printed within the postage stamp outline 220 in the second step 202. The instructions 222 listed in the postage stamp outline 220 for sending a video postcard may, for example include the following enumerated steps for the process illustrated in the images 200, 202, 204, and 206 of FIGS. 9A and 9B:

1. Stand in front of the screen.

2. Touch the video postcard button 210 (as in image 200).

3. Then press button 212 “Touch screen to begin” (See image 202).

4. Wait for countdown for video to start (here 10 seconds as shown at legend 214).

5. Video 216 will display on screen (shown in the second and third images 202, 204).

6. Touch the “OK” button 218 (See the third image 204).

7. Enter the email 224 you want to send the photo to (using keyboard 226, which appears on the screen below the postcard 220 in the fourth image 206).

8. Press “Send”button 226 (shown in the fourth image 206).

When using the built-in HD camera 70, the user may see the video or photo 216 displayed on the upper screen in step number (5) following the time period of step (4) controlled by a timer, e.g., ten seconds in this example. In FIG. 9A, the first step depicts selection of the video postcard function on the menu 54, followed by forming the image with the HD camera 70 built-in to the terminal 20 in the second step. To take the picture and form the image the user touches the screen to begin as in the second step at image 202. Alternatively, an additional step, e.g., “Send external image file” may be inserted into the instructions between steps (2) and (3) to send a file from an external source to the terminal 20 to be used as the photo for the video postcard.

FIG. 9B illustrates a second portion of the third example of sending a video postcard using the present invention. In the third step shown in the third image 204, the instructions remain in the lower region 34 of the display and the postcard image 216 appears in the upper region 32 of the screen with a button 218 labeled “OK.” Touching the OK button 218 signifies to the terminal 20 that it is OK to use the displayed image 216 in the video postcard. When the OK button 218 is touched, the display changes to a rendering of the video postcard 220 with a label 224 superimposed thereon requesting entry of the destination information of the addressee, which in this example maybe an on-line or email address as also shown in label 224. After entry of the email address in the label 224 using virtual alpha keyboard 228, touching the “Send” button 226 provided causes the transmission of the video postcard 220.

FIG. 10 illustrates a fourth example of an interactive information service of providing a coupon using the present invention. The process is depicted in three steps represented by three images 240, 242, and 244 in sequence, beginning with touching the screen 30 at the location of an ad 250 appearing in the lower region 34 of the menu page 54 as shown in the first step. In the response step two a menu page screen appears that depicts both a web page 252 of the vendor of the selected service that provides instructions for obtaining the coupon corresponding to the ad 250. The web page 252 may replicate the ad 250, along with an illustration of a coupon 254 and a “Send” button 256. Appearing below the web page 252 in image 242 during step two may also be a virtual alpha keyboard 258 for entry of destination information such as a mobile telephone number to receive the coupon at an external communications device 260 shown in the third image 244. Upon entering the destination information the user touches the send button 256. The terminal 20 then transmits a coupon file, perhaps as a text message, which then appears in the screen 262 of the external device 260 shown in the third image 244 as a coupon 264. The coupon 264 may include a message 266 that provides the details and terms of the coupon 264, and may include, for example a promotional code 268. In an alternate embodiment the software that controls the coupon delivery may include a step (not shown) for setting a time limit for requesting a coupon, such as the end of the current day or a specific clock time, and displaying that time limit on the screen of the external device 260.

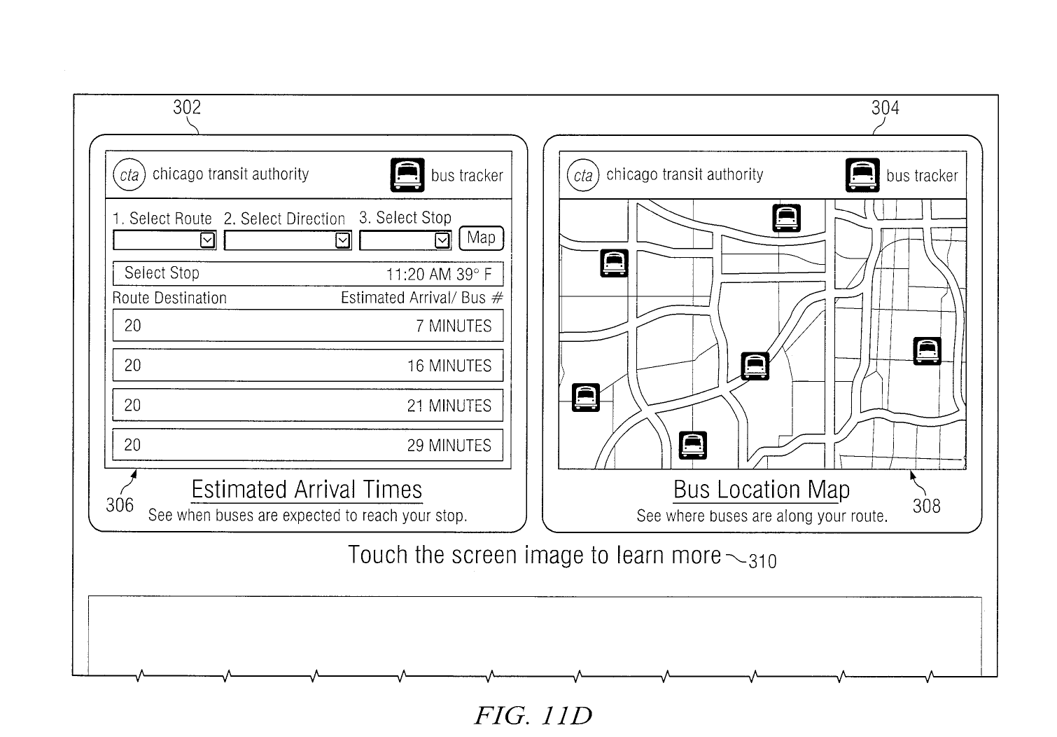

One other example of the many possible uses of the public interactive information terminal 20 according to the present invention is shown in FIG. 11. This figure, in parts 11A through 11D illustrates four examples of a display image that may appear in a region of the display 30 for attracting the attention of a potential user. These panels may appear in a timed sequence in the attract screen according to a playlist running within the terminal 20. In a first panel 280 FIG. 11A shows a handshake image 282 along with the statement 284 “Touch for job help nearby.” This display is intended to attract the interest of a user engaged in or considering a search for a job. Touching the display panel 282 may be followed by display of subsequent panels the user may follow by following prompts provided in the panels as they appear to provide further information or instructions for interacting with the display.

Continuing with FIG. 11, panel 286 in FIG. 11B shows an example of a web site or web page 288 of a charitable organization. The web site may be illustrated in conjunction with a message 290 to “Touch here to learn how” to support the particular agency. The web page 288 may also include a brief description of the organization and its donation policies or instructions. An example of a public interest message is shown in the panel 292 depicted in FIG. 11C, which may illustrate a notification message 294 about school closures in the vicinity of the terminal 20. As in the other similar display panels of FIG. 11, a legend 296 “Touch here for more information” may be provided on the panel 292 to direct a user interested in the work of the agency or foundation.

In yet another example depicted in panels 302 and 304 of FIG. 11D, a “Bus Tracker” display appears that may provide bus scheduling, location, and fares information in successive panels. The first panel 302 illustrated in FIG. 11D provides estimated arrival times 306 for selected bus routes at the location of the terminal 20 while a second panel 304 shown in FIG. 11D may provide a bus route map 308 showing nearby locations where several buses along the selected route will stop for passenger pick up or dismount. Either panel 302 or 304 may be accompanied by an instruction 310 such as “Touch the screen image to learn more.” The panels 302 and 304 may be displayed side-by-side as shown or one above the other.

While the invention has been shown in only one of its forms, but with several alternative embodiments and aspects, it is not thus limited but is susceptible to various changes and modifications without departing from the spirit thereof.

What is claimed is:

1. An interactive information terminal, comprising:
an interactive communication terminal having a touch sensitive display screen and configured to be installed in a fixed support, said terminal further configured for connection to electrical power and a network connection; and
a processor controlled by a main program and a suite of software applications stored in said terminal and operative in said communication terminal to respond to user inputs and selections entered via said touch sensitive display; wherein
said communication terminal automatically switches between a passive display mode and an active display mode by touching said display screen.

2. The information terminal of claim 1, wherein said communication terminal automatically returns to said passive display mode from said active display mode when a subsequent touching of said display screen fails to occur within a predetermined time interval.

3. The information terminal of claim 1, wherein said passive display mode comprises:
a periodically repeated sequence of images arranged according to a predetermined playlist to invite users to interact with said terminal.

4. The information terminal of claim 1, wherein said active display mode comprises:
a menu of possible user-initiated services associated with a browser application wherein each said service is represented by a button symbol on said menu such that touching said button launches said browser to a URL corresponding to said service.

5. The information terminal of claim 1, further comprising:
a main program operatively coupled to and accessible by said processor for managing said touch sensitive display including display of images and response to user's touch commands; and
a web browser accessible via said processor when a menu button is selected a user's touch.

6. The information terminal of claim 1, further comprising:
an internal web server operable with said main program to respond to a user selected menu button by calling an application associated with said selected menu button.

7. The information terminal of claim 1, further comprising:
a virtual keyboard coupled with said main program and operable in response to calling an application such that alphanumeric entry of data may be accomplished by touching symbols arrayed on a displayed image of said virtual keyboard on said display.

8. The information terminal of claim 1, further comprising:
a modem operatively coupled with said processor and said main program for enabling two-way communication with at least one broadband channel connected to a global communication network.

9. The information terminal of claim 1, further comprising:
a media player operatively coupled with said main program and said touch sensitive display for rendering viewable images on said display in association with a related application or a web browser initiation.

10. The information terminal of claim 1, wherein said communication terminal comprises:
a camera providing a digitized image output within a predetermined field of vision of said camera;
an image recognition application adapted to processing said digitized image output; and
a utility that requires a match between said digitized image output and a previously entered image stored in said information terminal.

11. The information terminal of claim 1, wherein said communication terminal comprises:
a camera providing a digitized image output of a person within a predetermined field of vision of said camera;
a video postcard application adapted to processing said digitized image output;
an editing application that enables a person to select at least one of a plurality of edits to the digitized image; and
a provision in said editing application for formatting said video postcard in a message with an address and for forwarding said video postcard thereto.

12. The information terminal of claim 1, wherein said communication terminal comprises:
a camera providing a digitized image output of a person within a predetermined field of vision of said camera;
a video postcard application adapted to processing said digitized image output;
an editing application that enables a person to select at least one of a plurality of edits to the digitized image; and
a memory for storing a postcard image file of said edited digitized image for subsequent transmission to a recipient.

13. The information terminal of claim 1, wherein said communication terminal comprises:
an input for entering a digitized image output into a designated communications port of said communication terminal;
a video postcard application adapted to processing said digitized image output;
an editing program that enables a user to select at least one of a plurality of edits to the digitized image; and
a memory for storing a postcard image file of said edited digitized image for subsequent transmission to a recipient.

14. The information terminal of claim 1, wherein said communication terminal comprises:
a menu page selection portion of said display screen adapted to request a virtual keyboard; and
a text program adapted to transfer a message entered upon said keyboard into a memory file.

15. The information terminal of claim 14, wherein said menu page selection portion comprises:
a log in section of said display screen having provision for entering log in information; and
a validation mechanism to confirm said log in information.

16. The information terminal of claim 14, further comprising:
a reader adapted to translate said message into a command instructing said terminal to respond to a request for advertising information; and
an application for displaying on said screen a response to said request.

17. The information terminal of claim 1, further comprising:
a public safety program adapted to override a present display sequence to display an emergency message of interest to citizens in a predetermined vicinity of said communications terminal.

18. The information terminal of claim 17, wherein said public safety program in said communication terminal comprises:
a touch sensitive information entry program adapted to receive citizen input information from an emergency site.

19. The information terminal of claim 1, wherein said communication terminal comprises:
a menu page selection portion of said display screen adapted to request a printed ticket or coupon;
a virtual keyboard adapted to receive entry of user information about said request; and
an application operable to respond to said request by transmitting a file containing said ticket to a user's mobile device.

20. A public interactive information network, comprising:
a plurality of interactive information terminals according to claim 1 disposed at designated public locations;
a communications infrastructure linking said plurality of interactive information terminals into a public network; and
at least one interactive data center coupled to said infrastructure and configured for responding to and fulfilling requests for information originating at any of said interactive information terminals.

21. The network of claim 20, wherein:
said designated public locations comprise locations formerly occupied by public pay telephone installations; and
said communications infrastructure comprises a pre-existing telephone network serving said pay telephone installations.

22. The network of claim 20, wherein said at least one interactive data center comprises:
at least one firewall;
a web server coupled to said infrastructure through said firewall;
a database server coupled to said web server; and
at least one database accessible to said database server.

23. The network of claim 20, further comprising:
an emergency response dispatch center connected to said infrastructure via a communications link.

24. The network of claim 20, further comprising:
an interactive network management office connected to said infrastructure via a communications link.
